(19) United States
(12) Patent Application Publication
(10) Pub. No.: US 2010/0215822 A1
(43) Pub. Date: Aug. 26, 2010

(54) MOUTHFEEL ENHANCING INGREDIENTS

(75) Inventor: Christoph Mueller, Princeton, NJ (US)

Correspondence Address: WINSTON & STRAWN LLP;PATENT DEPARTMENT, 1700 K STREET, N.W., WASHINGTON, DC, 20006, US

(73) Assignee: Firmenich SA, Geneva 8 (CH)

(21) Appl. No.: 12/738,896

(22) PCT Filed: Nov. 10, 2008
(86) PCT No.: PCT/IB08/54689

§ 371 Date: Apr. 20, 2010

Related U.S. Application Data
(60) Provisional application No. 60/987,179, filed on Nov. 12, 2007.

(51) Int. Cl. A23L 1/226; C07F 9/02

(52) U.S. Cl. 426/534; 558/180; 558/179

(57) ABSTRACT

The present invention relates to a method of using a compound of formula (I): (I) or formula (II) (II) wherein R1 and R2 independently represent a C₃ to C₁₈ alkyl group or alkenyl group, and R3 is selected from the group consisting of —H, —(CH₂CH₂N⁺(CH₃)₃), —(CH₂CH₂NH₃+), —(CH₂CH(NH₃+)COOH), —(CH₂CH(OH)CH₂OH), and —(C₆H₁₁O₆) to impart a mouthfeel effect, especially to low calorie beverages, such as teas, coffees and cola's.

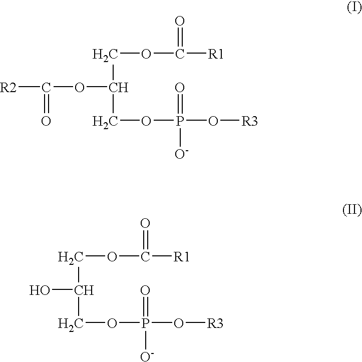

### TECHNICAL FIELD

The present invention relates to the field of flavor. More particularly, it concerns the use as taste enhancing ingredient of a phospholipid, in particular to impart mouthfeel sensations. The present invention also concerns the use of said compound in the flavor industry as well as the compositions or articles containing said compound.

### PRIOR ART

Sugar is the most commonly used sweetener and the taste of sugar is what people all over the world expect from a sweet product. Sugar imparts sweetness to the product but in addition to that, it provides a mouthfeel and an aftertaste which is pleasant.

Attempts have been made to analyze the components affecting the taste and texture of sugar, but the complexity of the system is so great that no clear picture of the active components has been obtained.

Due to the high caloric value of sugar, the use of artificial or non-sucrose sweeteners as sugar replacements in food technology has greatly increased, especially in diet and low-calorie foods and beverages. These artificial sweeteners are either essentially calorie-free, which are often referred to as low-calorie or intense sweeteners, or they have a significantly reduced calorie content, and products containing significant amounts of such sweeteners are known as low-calorie products. Examples of such low-calorie sweeteners include saccharin, aspartame, potassium acesulfame, sucralose, alitame, and cyclamate.

A problem with these low-calorie sweeteners is that, although they replace the sweetness of sucrose, they fail to replace its other characteristics, especially mouthfeel or body. This is particularly evident in reduced sugar beverages, often known as low calorie or diet drinks since a major component of the taste of such drinks is its mouthfeel and sweetness. For instance, a diet cola is often considered inferior in quality when compared to the cola having no sugar removed. Furthermore, many such low calorie beverages are considered to have a lingering, metallic aftertaste which reduces consumer preference for such beverages, and so it would be desirable to, at least partly mask such off-flavours.

The present invention seeks to address these needs and/or to provide an additive that can achieve the desired results.

Phospholipids are known for use in foods. For instance, phosphotidyl choline has been reported in U.S. Pat. No. 5,120,561 (Silva et al). According to this document, globular vesicles or liposomes are formed using the combination of phosphatidyl choline, phosphatidyl ethanolamine and water. The vesicles are then used to replace some or all of the fat in food and to act as a carrier, encapsulating agent, moisturizing agent, and depanner. According to column 3 lines 10 to 12, it is essential that vesicles or liposomes are formed first before addition to food. Thus, this document contemplates the spherical to structure of the vesicles as the necessary characteristic for achieving fat-replacement. This document does not therefore contemplate that such a compound alone or in combination can provide mouthfeel enhancing effects to replace at least partly the mouthfeel lost in sucrose-reduced foodstuffs, especially sugar reduced beverages.

Phosphatidyl choline is a component of lecithin. Lecithin is known as a mouthfeel enhancer. However, its use is limited to providing a fatty texture. This is different from replacing the mouthfeel of sugar and masking the taste of artificial sweeteners. For this reason, lecithin is often used in dairy products, where a fatty texture is considered desirable, but not in non-fatty foodstuffs where it can even be considered to deliver an undesirable texture and/or taste. For this reason, it is necessary to avoid the use of lecithin in order to avoid imparting an undesirable fatty note.

WO-A-2007/129251 (Firmenich S A) relates to a method of washing edible liquid oils with certain alcohols to provide a heavy and a light fraction and recovering the heavy fraction for use as a mouthfeel enhancing component. This provides a useful mouthfeel-enhancing product although a significant amount of alcohol residues are present in the fraction and the fraction remains a complex mixture of ingredients. Accordingly, it would be desirable to provide a product which can be prepared in an alternative manner and which avoids complex mixtures. Furthermore, the heavy fraction is believed to contain, as major components, mono-, di- and triacylglycerols. These are not the mouthfeel-enhancing compounds that are the subject of the present invention.

### DESCRIPTION OF THE INVENTION

We have now surprisingly discovered that a compound of formula (I):

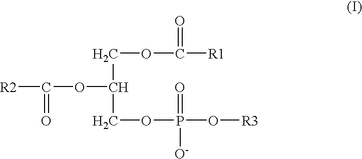

or formula (II)

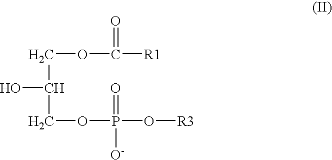

wherein R1 and R2 independently represent a C₃ to C₁₈ alkyl group or alkenyl group, and R3 is selected from the group consisting of —H, —(CH₂CH₂N⁺(CH₃)₃), —(CH₂CH₂NH₃⁺), —(CH₂CH(NH₃⁺)COOH), —(CH₂CH(OH)CH₂OH), and —(C₆H₁₁O₆), can be used to enhance the mouthfeel of low-calorie foodstuffs.

Therefore the present invention concerns a method to confer, enhance, improve or modify the mouthfeel properties of a flavouring composition or of a flavoured article, which method comprises adding to said composition or article at least one compound of formula (I):

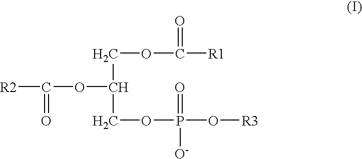

or formula (II)

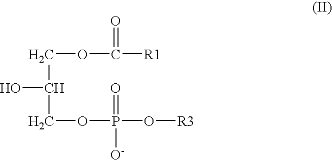

wherein R1 and R2 independently represent a C₃ to C₁₈ alkyl group or alkenyl group, and R3 is selected from the group consisting of —H, —(CH₂CH₂N⁺(CH₃)₃), —(CH₂CH₂NH₃⁺), —(CH₂CH(NH₃⁺)COOH), —(CH₂CH(OH)CH₂OH), and —(C₆H₁₁O₆), in a mouthfeel enhancing effective amount, with the proviso that the composition or article prepared according to this method is free of lecithin.

The compound(s) are not present in the form of a complex mixture of ingredients that are obtained as a heavy fraction of alcohol-washed oils. Mouthfeel enhancing compositions comprising the compounds according to formula (I) or formula (II) do not typically comprise the combination of mono, di and triacyl glycerols as major components. The compounds are not present as a component of lecithin and so can impart a desirable mouthfeel, especially to reduced sugar beverages, such as clear, carbonated cola's and the like without imparting an unwanted fatty note more associated with dairy products.

According to a preferred embodiment of the invention, a compound according to formula (I) or formula (II) is added to a flavouring composition in an amount comprised between 0.4% -20.0% by weight, relative to the total weight of said flavouring composition.

According to another preferred embodiment of the invention, a compound according to formula (I) or formula (II) is added to a flavoured article in an amount comprised between 0.0004% -0.02% by weight, relative to the total weight of said flavoured article.

The compounds of formula (I) or formula (II) are composed of a glycerol backbone, pendant hydrocarbyl groups of variable chain length and a phosphate functional group to which is bound to hydrogen or a further organic molecule.

In formula (I), R1 and R2 are independently selected from a C₃ to C₁₈, preferably C₄ to C₁₇, more preferably a C₆ to C₁₆ alkyl or alkenyl group.

R1 and/or R2 preferably contain 0 to 3 double bonds, more preferably 0 or 1 double bond. Most preferably R1 and R2 are free of double bonds.

In formula (II), R1 is selected from a C₃ to C₁₈, preferably C₄ to C₁₇, more preferably a C₆ to C₁₆ alkyl or alkenyl group, and preferably contains 0 to 3 double bonds, more preferably 0 or 1 double bond, most preferably no double bonds.

In compounds according to either formula, a very low degree of unsaturation in the alkyl chain is desired in order to provide more stable mouthfeel enhancing compounds with reduced likelihood of off-notes associated therewith.

R3 is selected from the group consisting of —H, —(CH₂CH₂N⁺(CH₃)₃), —(CH₂CH₂NH₃⁺), —(CH₂CH(NH₃⁺)COOH), —(CH₂CH(OH)CH₂OH), and —(C₆H₁₁O₆).

Preferred classes of compounds of formula (I) and (II) are phosphatidic acids, phosphatidyl cholines, phosphatidyl ethanolamines, phosphatidyl serines, phosphatidyl glycerols and phosphatidyl inositols. Of these, phosphatidyl cholines, phosphatidyl glycerols, and phosphatidic acids are particularly preferred. These classes of compounds are all found to impart or improve the mouthfeel of the preparation to which they are added. Of these classes of compounds, highly preferred are phosphatidyl cholines. This class of compound has been found to have a particularly desirable mouthfeel enhancing effect in low calorie foodstuffs, and especially in low-calorie beverages.

The skilled person will readily appreciate that, although not explicitly mentioned, the compounds according to formula (I) or formula (II) include the edible salts thereof.

Commercially available compounds according to formula (I) or formula (II) include dicaproylphosphatidic acid (830841), dilauroylphosphatidic acid (840635), dip almitoylphosphatidic acid (830855), dioleoylphosphatidic acid (840875), dicaproylphosphatidyl glycerol (840432), dilauroylphosphatidyl glycerol (840435), dipalmitoylphosphatidyl glycerol (840455), dioleoylphosphatidyl glycerol (840475), dicaproylphosphatidyl choline (850305), dicapryloylphosphatidyl choline (850315), dicaprylphosphatidyl choline (850325), dilauroylphosphatidyl choline (850335), dimyristoylphosphatidyl choline (850345), dipalmitoylphosphatidyl choline (850355), dioleoylphosphatidyl choline (850375), dicaproylphosphatidyl ethanolamine (850697), dilauroylphosphatidyl ethanolamine (850702), dipalmitoylphosphatidyl ethanolamine (850705), dioleoylphosphatidyl ethanolamine (850725), 1-capryloyl-2-hydroxy-glycero-3-phosphocholine (855175), 1-capryl-2-hydroxy-glycero-3-phosphocholine (855375), 1-lauroyl-2-hydroxy- glycero-3-phosphocholine (855475), 1-myristoyl-2-hydroxy-glycero-3-phosphocholine (855575), 1-palmitoyl-2-hydroxy-glycero-3-phosphocholine (855675), 1-oleoyl-2-hydroxy-glycero-3-phosphocholine (845875), 1-palmitoyl-2-hydroxy-glycero-3-phosphoglycerol (858122), 1-oleoyl-2-hydroxy-glycero-3-phosphoglycerol (858125), all ex Avanti Polar Lipids, Inc., Alabama, USA.

As mentioned above, the invention concerns the use of a compound of formula (I) or formula (II) as a mouthfeel agent. By “use of a compound of formula (I) or formula (II)” it is to be understood here also the use of any compounded composition containing a compound according to formula (I) and/or (II) which can be advantageously employed in flavours and foods industry as mouthfeel enhancing ingredient. The expression “compounded flavouring composition” has the general meaning in the art, that is to say a composition obtained by admixing together various ingredients of different origin (natural or synthetic).

The compounded flavouring compositions mentioned above are also another object of the present invention. Said compounded flavouring composition comprises:

i) as mouthfeel enhancing ingredient, at least one compound of formula (I):

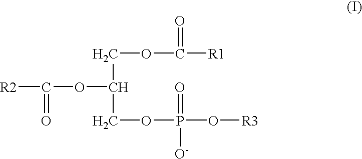

or formula (II)

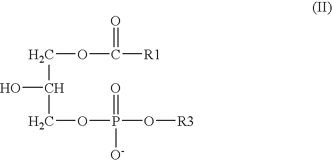

wherein R1 and R2 independently represent a C₃ to C₁₈ alkyl group or alkenyl group, and R3 is selected from the group consisting of —H, —(CH₂CH₂N⁺(CH₃)₃), —(CH₂CH₂NH₃⁺), —(CH₂CH(NH₃⁺)COOH), —(CH₂CH(OH)CH₂OH), and —(C₆H₁₁O₆),

ii) at least one ingredient selected from the group consisting of a flavour carrier and a flavour base; and

iii) optionally at least one flavour adjuvant.

with the proviso that the composition is free of lecithin.

The term “flavouring composition” has the usual meaning in the art in that it is a composition which imparts a hedonic effect, i.e. is able to impart or modify in a pleasant way the taste of a preparation, and not just as imparting a taste.

The proportions in which the compounds according to the invention can be incorporated into the various compositions vary within a wide range of values. These values are dependent on the nature of the article to be flavoured and on the desired organoleptic effect as well as the nature of the co-ingredients in a given base when the compounds according to the invention are mixed with flavouring co-ingredients, solvents or additives commonly used in the art. Typical examples of said proportions are given above.

By “flavour carrier” we mean here a material that is practically neutral in terms of flavour, such that it does not significantly alter the organoleptic properties of flavouring ingredients. The carrier may be a liquid or a solid, though it is preferably a liquid since the invention finds greatest utility in beverages.

As liquid carrier one may cite, as non-limiting examples, an emulsifying system, i.e. a solvent and a surfactant system, or a solvent commonly used in flavours. A detailed description of the nature and type of solvents commonly used in flavour cannot be exhaustive. However, one can cite as non-limiting example solvents such as propylene glycol, glycerin, triacetine, triethyl citrate, benzylic alcohol, ethanol, vegetal oils or terpenes.

As solid carrier one may cite, as non-limiting examples, absorbing gums or polymers, or yet encapsulating materials. Examples of such materials may comprise wall-forming and plasticizing materials, such as mono, di- or trisaccharides, natural or modified starches, hydrocolloids, cellulose derivatives, polyvinyl acetates, polyvinylalcohols, proteins or pectins, or yet the materials cited in reference texts such as H. Scherz, Hydrokolloids : Stabilisatoren, Dickungs- und Geliermittel in Lebensmittel, Band 2 der Schriftenreihe Lebensmittelchemie, Lebensmittelqualität, Behr's Verlag GmbH & Co., Hamburg, 1996. Encapsulation is a well known process to a person skilled in the art, and may be performed, for instance, using techniques such as spray-drying, agglomeration and extrusion; or it may consist of a coating encapsulation, such as simple and complex coacervation techniques.

Generally speaking, by “flavour base” we mean here a composition comprising at least one flavouring co-ingredient.

Said flavouring co-ingredient is not of formula (I) or formula (II). Moreover, by “flavouring co-ingredient” it is meant here a compound, which is used in flavouring preparation or composition to impart a hedonic effect. In other words such a co-ingredient, to be considered as being a flavouring one, must be recognized by a person skilled in the art as being able to impart or modify in a positive or pleasant way the odour or taste of a composition, and not just as having a taste.

The nature and type of the flavouring co-ingredients present in the base do not warrant a more detailed description here, which in any case would not be exhaustive, the skilled person being able to select them on the basis of its general knowledge and according to intended use or application and the desired organoleptic effect. In general terms, these flavouring co-ingredients belong to chemical classes as varied as alcohols, aldehydes, ketones, esters, ethers, acetates, nitriles, terpene hydrocarbons, nitrogenous or sulphurous heterocyclic compounds and essential oils, and said perfuming co-ingredients can be of natural or synthetic origin. Many of these co-ingredients are in any case listed in reference texts such as the book by S. Arctander, Perfume and Flavour Chemicals, 1969, Montclair, N.J., USA, or its more recent versions, or in other works of a similar nature, as well as in the abundant patent literature in the field of flavour. It is also understood that said co-ingredients may also be compounds known to release in a controlled manner various types of flavouring compounds.

Generally speaking, by “flavour adjuvant” we mean here an ingredient capable of imparting additional added benefit such as a colour, a particular light resistance, chemical stability, etc. A detailed description of the nature and type of adjuvant commonly used in flavouring bases cannot be exhaustive, but it has to be mentioned that said ingredients are well known to a person skilled in the art.

An invention's composition consisting of at least one compound of formula (I) or formula (II) and at least one flavour carrier represents a particular embodiment of the invention as well as a flavouring composition comprising at least one compound of formula (I) or formula (II), at least one flavour carrier, at least one flavour base, and optionally at least one flavour adjuvant. However, the compositions must be free of lecithin.

Flavouring compositions according to the invention comprising, as class of compound according to formula (I) or formula (II), phosphatidyl choline are preferred.

The possibility of having, in the compositions mentioned above, more than one compound of formula (I) or formula (II) is important as it enables the provision of a balanced mouthfeel without any one compound dominating. Thus a variety in strength and duration of mouthfeel can be achieved and yet, if one compound has excessive secondary to flavours or taste effects which, if used alone, would be detrimental to the overall effect, a flavourist can blend the compounds to avoid this.

In a flavouring composition, the compound of the invention is preferably present in an amount comprised between 0.4 to 20% by weight, relative to the total weight of the flavouring composition. At these levels, sufficient compound is present to achieve the desired mouthfeel enhancing and sugar replacement effects. Below this level, insufficient effect is achieved whilst, above this level, the presence of secondary, often undesirable, notes and tastes becomes more apparent.

The compound according to the invention is preferably present in a foodstuff, in particular in a beverage. Therefore, a flavoured article according to the invention comprises the functional formulation, as well as optionally additional benefit agents, corresponding to a desired foodstuff, e.g. teas or low calorie carbonated beverages such as low calorie cola's, and a mouthfeel enhancing amount of a compound according to the invention.

The nature and type of the constituents of beverages do not warrant a more detailed description here, which in any case would not be exhaustive, the skilled person being able to select them on the basis of his general knowledge and according to the nature of the product.

Suitable foodstuffs include but are not limited to low-calorie beverages, especially low-calorie carbonated beverages, most preferably cola's, since it has surprisingly been found that the mouthfeel enhancing effect is most pronounced in reduced sugar beverages.

The proportions in which the compounds according to the invention can be incorporated into the various aforementioned articles or compositions vary within a wide range of values. These values are dependent on the nature of the article to be flavoured and on the desired organoleptic effect as well as the nature of the co-ingredients in a given base when the compounds according to the invention are mixed with flavouring co-ingredients, solvents or additives commonly used in the art.

Nevertheless, concentrations in the order of 0.0004% to 0.02% by weight, when these compounds are incorporated into sugar-reduced beverages, otherwise known as low-calorie beverages, are preferred. Even more preferred is from 0.002 to 0.015% by weight, and most preferred is from 0.006 to 0.01% by weight.

The invention will now be described in further detail by way of the following examples, wherein the abbreviations have the usual meaning in the art.

### Example 1

### Evaluation of the Mouthfeel Enhancer

5 mg of each of the following compounds, all obtained from Avanti Polar Lipids, Inc., Alabama, USA was added to 300 mL of a commercially available Diet Cola in a bottle. The bottles were then closed and shaken by hand for 1 min at room temperature. Following this, the bottles were sonicated for 5 min in an ultrasonic bath and then stored at room temperature overnight. All samples were tasted blind by 4-5 skilled panelists and assessed, by comparison with a Diet Cola not containing any mouthfeel enhancer, for mouthfeel, sweetness, off-notes and other descriptors.

The results are given in the following table:

TABLE 1

| Mouthfeel Enhancer | Results |
|---|---|
| Dicaproylphosphatidic acid | Thin, typical diet cola, slight metallic off-note, |
| | sweet, acidic, more lemon, lingering/long lasting, |
| | oily |
| Dilauroylphosphatidic acid | More Mouthfeel, fatty, fuller, clean, acidic, more |
| | sour and harsh, oily |
| Dipalmitoylphosphatidic acid | More mouthfeel, fatty, fuller, heavy, sweeter, |
| | smooth, good mouthfeel, slightly oily, no off-note |
| Dioleoylphosphatidic acid | More mouthfeel, fatty, fuller, very drying, |
| | mouthcoating, less lingering, oily |
| Dicaproylphosphatidyl glycerol | Fatty, lingering, less sweet, some mouthfeel, still |
| | metallic, fuller, sweeter, less lingering diet aftertaste, |
| | off-note, waxy, sour |
| Dilauroylphosphatidyl glycerol | Sweeter, similar to reference, fatty, off-note, waxy, |
| | good sweetness, slightly flat aroma |
| Dipalmitoylphosphatidyl | Seems less carbonated, less acidic, more citrusy |
| glycerol | aroma, better mouthfeel, less metallic, good |
| | sweetness and mouthfeel, less lingering aftertaste, |
| | no off-note |
| Dioleoylphosphatidyl glycerol | Sweeter, lingering, egg yolk mouthfeel, similar to |
| | reference, fuller, less lingering diet aftertaste, waxy, |
| | chemical, slight off-note on taste |
| Dicaproylphosphatidyl choline | More acidity than others, sweeter, smoother, fuller, |
| | more mouthfeel, similar mouthfeel |
| Dicapryloylphosphatidylcholine | Some mouthfeel, similar to reference, slight off-note |
| Dicaprylphosphatidylcholine | More mouthfeel, good mouthfeel, more body, |
| | creamy, sl. more sweet, good sweetness |
| Dilauroylphosphatidyl choline | Good sweetness, more mouthfeel than reference, |
| | sweeter, smooth mouthfeel, fuller, slightly fatty, |
| | neutral in taste vs. reference |
| Dimyristoylphosphatidylcholine | More mouthfeel, good mouthfeel, creamy, flat, less |
| | carbonated, sweeter |
| Dipalmitoylphosphatidyl | Sweeter, nice sweetness but lingering, good |
| choline | mouthfeel, no off-note, smoother but little |
| | difference, slightly fuller, slightly fatty |
| Dioleoylphosphatidyl choline | No off-note, no big difference in mouthfeel, similar |
| | to reference; similar in taste, bitter aftertaste |
| Dicaproylphosphatidyl | Quite metallic, slightly more fatty, sweet lingering, |
| ethanolamine | thin, less sweet, less flavor, lingering fatty taste; |
| Dilauroylphosphatidyl | Very similar to reference, slightly fuller, sweeter, |
| ethanolamine | citrusy |
| Dipalmitoylphosphatidyl | Less carbonated, sweeter, some mouthfeel, similar to |
| ethanolamine | reference, good sweetness and mouthfeel, not |
| | completely soluble, less flavor, lingering fatty |
| Dioleoylphosphatidyl | Slightly sweeter, slightly more bitter, fatty/waxy off- |
| ethanolamine | note, not completely soluble |
| 1-Capryloyl-2-hydroxy-glycero- | slightly more mouthfeel, close to reference |
| 3-phosphocholine | |
| 1-Capryl-2-hydroxy-glycero-3- | slightly more mouthfeel, close to reference |
| phosphocholine | |
| 1-Lauroyl-2-hydroxy-glycero-3- | sweet, slightly bitter, slightly more mouthfeel, close |
| phosphocholine | to reference |
| 1-Myristoyl-2-hydroxy-glycero- | slightly more mouthfeel, similar to reference |
| 3-phosphocholine | |
| 1-Palmitoyl-2-hydroxy-glycero- | sweeter, less sour, slightly more mouthfeel, similar |
| 3-phosphocholine | to reference |
| 1-Oleoyl-2-hydroxy-glycero-3- | more mouthfeel, more round, good mouthfeel and |
| phosphocholine | sweetness, creamy |
| 1-Palmitoyl-2-hydroxy-glycero- | slightly more mouthfeel, creamy, similar to reference |
| 3-phosphoglycerol | |
| 1-Oleoyl-2-hydroxy-glycero-3- | less sour, more sweet, similar to reference |
| phosphoglycerol | |

The results demonstrate that all of the compounds provided mouthfeel. Excellent results were achieved with dicaprylphosphatidyl choline, dilauroylphosphatidyl choline, dimyristoylphosphatidyl choline, dipalmitoylphosphatidyl choline, 1-oleoyl-2-hydroxy-glycero-3-phosphocholine, dipalmitoylphosphatidyl glycerol, dicaproylphosphatidyl choline, dipalmitoylphosphatidic acid because they were found to deliver the mouthfeel required in the reduced-sugar beverage without further generating undesirable off-notes.

### Example 2

### Preparation of a Low Calorie Beverage Comprising the Mouthfeel Enhancer

Two diet cola syrups were prepared by admixing the following ingredients:

Parts by
weight/volume

| Ingredients | A) | | B) | |
|---|---|---|---|---|
| Cola Flavor(1) | 6.0 | g | 6.0 | g |
| Caramel BS 400 | 4.44 | g | 4.44 | g |
| Aspartame | 2.22 | g | 2.22 | g |
| Acesulfame-K | 0.26 | g | 0.26 | g |
| Sodium benzoate (25% w/v solution) | 7.0 | mL | 7.0 | mL |
| Phosphoric acid (85% w/v solution) | 3.0 | mL | 3.0 | mL |
| Citric acid (50% w/v solution) | 1.5 | mL | 1.5 | mL |
| Caffeine | 0.78 | mL | 0.78 | mL |
| 1,2-dilauroylphosphatidyl choline | — | | 0.2 | g |
| qs. with water to | 1000 | mL | 1000 | mL |

(1)ex Firmenich (reference 599077T)

The addition of 1 part by volume of composition A) or B) to 5 parts carbonated water provided two new diet cola beverages, respectively A′) and B′).

The flavour of diet cola B′) in a blind test was described as having a better mouthfeel, also described as being fuller in taste, and a cleaner sweet taste than diet cola A′).

Therefore, the invention's compound not only is able to impart an appreciated improved mouthfeel, but also generates, contrary to the prior art compounds, a sweet taste sensation that is preferred over that of the diet cola beverage without the invention's compound.

### Example 3

### Preparation of a Low Calorie Beverage Comprising the Mouthfeel Enhancer

Two diet cola syrups were prepared by admixing the following ingredients:

Parts by
weight/volume

| Ingredients | A) | | B) | |
|---|---|---|---|---|
| Cola Flavor 599077T | 6.0 | g | 6.0 | g |
| Caramel BS 400 | 4.44 | g | 4.44 | g |
| Aspartame | 2.22 | g | 2.22 | g |
| Acesulfame-K | 0.26 | g | 0.26 | g |
| Sodium benzoate (25% w/v solution) | 7.0 | mL | 7.0 | mL |
| Phosphoric acid (85% w/v solution) | 3.0 | mL | 3.0 | mL |
| Citric acid (50% w/v solution) | 1.5 | mL | 1.5 | mL |
| Caffeine | 0.78 | mL | 0.78 | mL |
| 1,2-dilauroylphosphatidyl choline | — | | 0.1 | g |
| qs. with water to | 1000 | mL | 1000 | mL |

The addition of 1 part by volume of composition A) or B) to 5 parts carbonated water provided two new diet cola beverages, respectively A′) and B′).

The flavour of diet cola B′) in a blind test was best described as being sweeter, having more mouthfeel, also described as being fuller in taste than diet cola A′). Other than that diet cola B′) was described as being neutral in taste compared to diet cola A′).

Therefore, the invention's compound not only is able to impart an appreciated improved mouthfeel, but also generates, contrary to the prior art compounds a sweet taste sensation that is preferred over that of the diet cola beverage without the invention's compound.

### Example 4

### Preparation of a Low Calorie Beverage Comprising the Mouthfeel Enhancer

Two diet cola syrups were prepared by admixing the following ingredients:

Parts by
weight/volume

| Ingredients | A) | | B) | |
|---|---|---|---|---|
| Cola Flavor 599077T | 6.0 | g | 6.0 | g |
| Caramel BS 400 | 4.44 | g | 4.44 | g |
| Aspartame | 2.22 | g | 2.22 | g |
| Acesulfame-K | 0.26 | g | 0.26 | g |
| Sodium benzoate (25% w/v solution) | 7.0 | mL | 7.0 | mL |
| Phosphoric acid (85% w/v solution) | 3.0 | mL | 3.0 | mL |
| Citric acid (50% w/v solution) | 1.5 | mL | 1.5 | mL |
| Caffeine | 0.78 | mL | 0.78 | mL |
| 1,2-Dipalmitoylphosphatidyl glycerol | — | | 0.1 | g |
| qs. with water to | 1000 | mL | 1000 | mL |

The addition of 1 part by volume of composition A) or B) to 5 parts carbonated water provided two new diet cola beverages, respectively A′) and B′).

The flavour of diet cola B′) in a blind test was best described as seeming less carbonated, being less acidic, having more citrusy aroma, better and more mouthfeel, a less metallic and less lingering aftertaste, and a better sweetness than diet cola A′). No aroma off-note was described in diet cola B′).

Therefore, the invention's compound is both able to impart an appreciated improved mouthfeel, and generate, contrary to the prior art compounds, a sweet taste sensation that is preferred over that of the diet cola beverage without the invention's compound.

### Example 5

### Preparation of a Low Calorie Beverage Comprising the Mouthfeel Enhancer

Two diet cola syrups were prepared by admixing the following ingredients:

| | Parts by | | | |
|---|---|---|---|---|
| | weight/volume | | | |
| Ingredients | A) | | B) | |
| Cola Flavor 599077T | 6.0 | g | 6.0 | g |
| Caramel BS 400 | 4.44 | g | 4.44 | g |
| Aspartame | 2.22 | g | 2.22 | g |
| Acesulfame-K | 0.26 | g | 0.26 | g |
| Sodium benzoate (25% w/v solution) | 7.0 | mL | 7.0 | mL |
| Phosphoric acid (85% w/v solution) | 3.0 | mL | 3.0 | mL |
| Citric acid (50% w/v solution) | 1.5 | mL | 1.5 | mL |
| Caffeine | 0.78 | mL | 0.78 | mL |
| 1-oleoyl-2-hydroxy-glycero-3-phosphocholine | — | | 0.1 | g |
| qs. with water to | 1000 | mL | 1000 | mL |

The addition of 1 part by volume of composition A) or B) to 5 parts carbonated water provided two new diet cola beverages, respectively A′) and B′).

The flavour of diet cola B′) in a blind test was best described as having more mouthfeel, seeming more round, having good mouthfeel and sweetness, and being more creamy than diet cola A′). No aroma off-note was described in diet cola B′).

Therefore, the invention's compound is both able to impart an appreciated improved mouthfeel, and generate, contrary to the prior art compounds, a sweet taste sensation that is preferred over that of the diet cola beverage without the invention's compound.

1. to 12. (canceled)

13. A mouthfeel enhancing composition comprising at least one of a compound of formula (I): 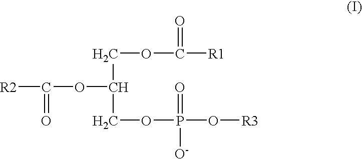
or of formula (II) 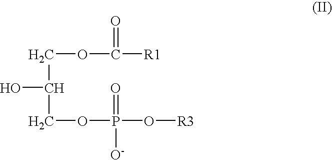
wherein R1 and R2 independently represent a C₃ to C₁₈ alkyl group or alkenyl group, and R3 is selected from the group consisting of —H, —(CH₂CH₂N⁺(CH₃)₃), —(CH₂CH₂NH₃⁺), —(CH₂CH(NH₃⁺)COOH), —(CH₂CH(OH)CH₂OH), and —(C₆H₁₁O₆), with the proviso that the composition is free of lecithin.

14. A compounded flavouring composition comprising:
i) the mouthfeel enhancing ingredient according to claim 13;
ii) at least one ingredient selected from the group consisting of a flavour carrier and a flavour base; and
iii) optionally, at least one flavour adjuvant.

15. The flavouring composition according to claim 14, characterized in that the compound according to formula (I) or formula (II) is alk(en)yl phosphatidyl choline.

16. A method to confer, enhance, improve or modify the mouthfeel properties or the mouthfeel of a flavouring composition or of a flavoured article, which method comprises adding to the composition or article the mouthfeel enhancing composition according to claim 13.

17. The method according to claim 16, wherein the mouthfeel enhancing composition is added in an amount effective to confer, enhance, improve or modify the volume, body and fullness of a mouthfeel of a flavouring composition or of a flavoured article, without imparting a fatty texture thereto.

18. The method according to claim 16, wherein the compound according to formula (I) or formula (II) is added to a flavouring composition in an amount comprised between 0.4% to 20% by weight, based on the total weight of the flavoured article.

19. The method according to claim 16, wherein the compound according to formula (I) or formula (II) is added to a flavoured article in an amount comprised between 0.0004% and 0.02% by weight, based on the total weight of the flavoured article.

20. The method according to claim 16, wherein the compound (I) is an alk(en)yl phosphatidyl choline.

21. The method according to claim 16, which further comprises adding a mixture of two or more different compounds according to formula (I) or formula (II) to achieve the desired mouthfeel of the flavouring composition or flavoured article.

22. A method to confer, enhance, improve or modify the mouthfeel properties or the mouthfeel of a flavouring composition or of a flavoured article, which method comprises adding to the composition or article the compounded flavouring composition according to claim 14.

23. The method according to claim 22, wherein the mouthfeel enhancing composition is added in an amount effective to confer, enhance, improve or modify the volume, body and fullness of a mouthfeel of a flavouring composition or of a flavoured article, without imparting a fatty texture thereto.

24. The method according to claim 22, wherein the compound according to formula (I) or formula (II) is added to a flavouring composition in an amount comprised between 0.4% to 20% by weight, based on the total weight of the flavoured article.

25. The method according to claim 22, wherein the compound according to formula (I) or formula (II) is added to a flavoured article in an amount comprised between 0.0004% and 0.02% by weight, based on the total weight of the flavoured article.

26. The method according to claim 22, wherein the compound (I) is an alk(en)yl phosphatidyl choline.

27. The method according to claim 22, which further comprises adding a mixture of two or more different compounds according to formula (I) or formula (II) in the composition to achieve the desired mouthfeel of the flavouring composition or flavoured article.

28. The flavouring composition or flavoured article produced according to the method of claim 16.

29. The flavouring composition or flavoured article produced according to the method of claim 22.

30. A flavoured article comprising:
i) as flavouring ingredient, the mouthfeel enhancing ingredient according to claim 13; and
ii) a foodstuff base.

31. The flavoured article according to claim 30, wherein the foodstuff is a reduced sugar beverage.

32. A flavoured article comprising:
i) as flavouring ingredient, the article the compounded flavouring composition according to claim 14; and
ii) a foodstuff base.

33. The flavoured article according to claim 32, wherein the foodstuff is a reduced sugar beverage.
